(19) United States
(12) Patent Application Publication
(10) Pub. No.: US 2005/0205606 A1
(43) Pub. Date: Sep. 22, 2005

(54) Process for mixing and device for the regulation of the fill level of pasty multi-component materials in containers

(75) Inventors: Klaus-Dieter Nehren, Dormagen (DE); Alf Memmer, Ratingen (DE); Norbert Weber, Koln (DE); Udo Friese, Hagen (DE)

Correspondence Address: Norris, McLaughlin & Marcus P.A., 18th Floor, 875 Third Avenue, New York, NY, 10022, US

(73) Assignee: Heraeus Kulzer GmbH, Hanau (DE)

(21) Appl. No.: 11/036,843

(22) Filed: Jan. 14, 2005

(30) Foreign Application Priority Data
Jan. 16, 2004 (DE) 10 2004 002 654.8

(51) Int. Cl. B67D 5/52

(52) U.S. Cl. 222/145.5

(57) ABSTRACT

Module for adjustment of the fill level of components in the containers of a multi-component mixing device, which is interchangeable with a static or dynamic mixer of said multicomponent device, into which amounts of the individual components are discharged until a predetermined ratio of said components is reached, at which time the module is removed and replaced by the static or dynamic mixer.

The invention relates to a mixing process and a device for the regulation of the fill level in containers with pasty multi-component materials to be mixed.

Multi-component materials for automixing systems are offered in plastic bags or double cartridges. Therein all the components must have the same volume, or, in the case of mixing ratios deviating from 1:1, the same fill level, so that the correct ratio of the components is discharged during application.

As a rule, the individual components are conducted through a mixing attachment (in the following called a “mixer”) with a static or dynamic mixing device, before they are fed for application and later cure. Such mixers are usually attached to the discharge device or the dosing device for the cartridges or plastic bags.

Since for technical reasons it is not possible during the filling of the cartridges/bags to always set exactly the same fill level, overdosing of one of the components usually occurs during the initial application of the materials.

The resulting incorrectly dosed mixture then also still partially remains in the mixer during the further conveyance and mixing and is carried along. The material with the incorrect mixing ratio often does not cure and thus must be disposed of in pasty form, which can lead to contamination. Due to this, relatively large amounts of material frequently have to be discarded. One makes do by the components being pressed until the user is of the opinion, based on her/his experience, that a functioning, curing mixture has arisen. This can lead to further increased material loss.

It was the objective to develop a device which is used to bring all the container's individual chambers filled with components to be mixed to an equal fill level before the multi-component material is conveyed through a static or dynamic mixer to be attached subsequently, where said device is to be produced as economically as possible and causes a low loss of material and as little contamination as possible.

The objective is realized by a hollow attachment, into which the components—without being mixed—are discharged until the fill level of the component containers is equal. The attachment can, like the mixer, be attached to the dosing device in such a manner that it can be removed. Material is conveyed into the attachment until both components are recognizably conveyed. For this purpose, the attachment is advantageously transparent.

The material to be discarded is then located within the hollow space of the device. Thereafter the hollow attachment is discarded with the discharged material and replaced by the functional mixer.

The invention thus relates to a device D), for the regulation of the fill level in containers with pasty multi-component materials to be mixed, as an addition to a mixing arrangement with
A) separate containers for the individual components, each with an opening;
B) discharge device or the dosing device for the conveyance of the components from the openings;
C) a static or dynamic mixer for attachment to the dosing device so that it is connected to the openings of the containers and the components can flow through it;
   where the device D) according to the invention constitutes a hollow attachment without mixing function and with separate inlet openings (2, 3) for each component, said hollow attachment comprising at least one hollow space (4, 5) as well as means for attachment to the dosing device B) at the location (2, 3) where the static or dynamic mixer C) is intended to be attached.

Expediently the empty housing of the mixer, without the mixing element otherwise present, can be used as the hollow attachment. This part already has the necessary fastening device for attachment to the discharge device. It is possible to make the outlet opening such that it can be closed with a cover or to equip it with a valve. In this way a cleaner uptake and disposal of the discharged material is ensured.

The means for attachment to the dosing device can be, for example, screw threads or plug-in connectors, latch connectors, or bayonet connectors, as are familiar to one skilled in the art.

The invention will be explained with the aid of the figures as follows:

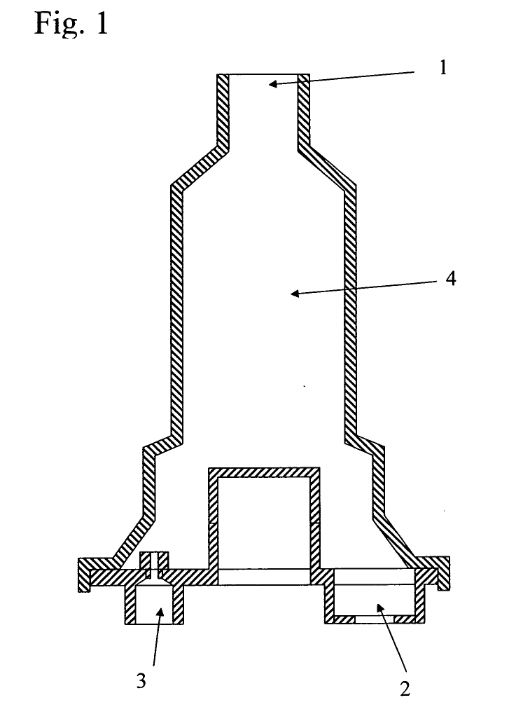

FIG. 1 shows the hollow attachment with a hollow space 4

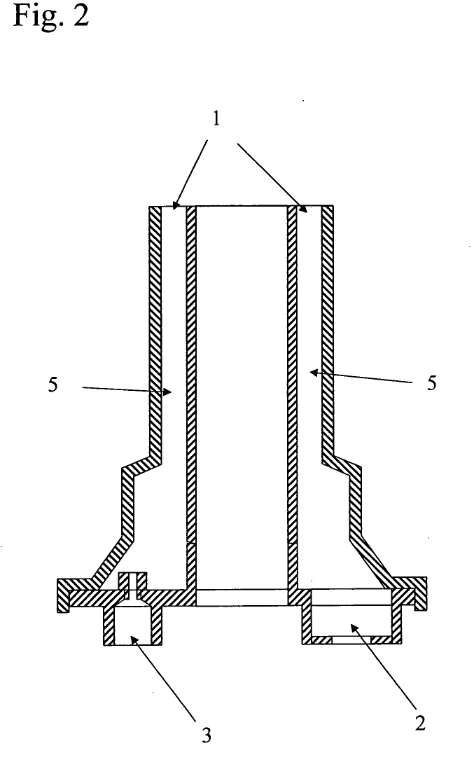

FIG. 2 shows the hollow attachment with two hollow spaces 5.

The material feed flows through the openings 2, 3 into the hollow spaces until all the components have been visibly conveyed and thus the intended mixing ratio is reached. In so doing, the components can be conducted into a common hollow space 4 or into separate hollow spaces 5. Subsequently, the hollow attachment is removed and replaced by the mixer.

The invention also relates to a process for the mixing of pasty multi-component materials in predefined amount ratios, where the feed in which the amount ratios of the components lie outside of the intended range is trapped in a separate hollow attachment and disposed of therein, where said separate hollow attachment has at least one hollow space 4, 5 and is to be attached to the dosing device at that point where the static or dynamic mixer is intended to be attached.

The process steps can be described in the following manner:
a) the above-described device D) is mounted on the discharge or dosing device B) at the location (2, 3) where the static or dynamic mixer is intended to be attached,
b) the discharge or dosing device B) is actuated,
c) the feed in which the amount ratios of the components lie outside of the intended range is trapped in the device D),
d) the device D) is taken off and disposed of, and subsequently
   the mixer C) is attached and the components are mixed.

It is possible in addition to structure the openings 1, 2, 3 of the device so that they can be closed in order to avoid contamination entirely.

Advantages of the realization according to the invention are, in particular, the reduction of the volume of waste and the cleaner handling of the waste.

Application of the device according to the invention is possible for all the multi-component systems in which there is conveyance, dosing, and, at the same time, mixing or homogenization by means of a static or dynamic mixer.

1. A removably attachable module for adjustment of the fill level in the containers of a multi-component mixing device comprising
A) separate containers for the individual components to be mixed, each having a discharge opening;
B) a discharge device or dosing device for the conveyance of components from the containers through the discharge openings;
C) a static or dynamic mixer removably connected to the discharge openings of the containers;
wherein the module comprises a hollow attachment without mixing elements and has separate inlet openings for each component, said hollow attachment comprising at least one hollow space and being removably attachable to the discharge openings of the containers, interchangeably with said static or dynamic mixer.

2. Process for the mixing of pasty multi-component materials in predetermined ratios in a multicomponent mixing device having individual containers for individual components to be mixed with each other and a removably attachable static or dynamic mixer through which the components of said individual containers are discharged to be mixed, wherein a module of claim 1 is removably attached to said multicomponent mixing device in place of said static or dynamic mixer, amounts of the individual components are discharged into said module until the ratio of the components being discharged approximates said predetermined ratio, at which point the module is removed and replaced by said static or dynamic mixer.

3. (canceled)
